(19) United States
(12) Patent Application Publication
(10) Pub. No.: US 2004/0071305 A1
(43) Pub. Date: Apr. 15, 2004

(54) Faceplate

(76) Inventor: Peter Frederiksen, Hellerup (DK)

Correspondence Address: Dykema Gossett, Suite 300 West, 1300 I Street NW, Washington, DC, 20005-3306, US

(21) Appl. No.: 10/466,362

(22) PCT Filed: Jan. 22, 2002
(86) PCT No.: PCT/DK02/00044

(30) Foreign Application Priority Data
Feb. 1, 2001 (DK) PA 2001 00170

(51) Int. Cl. B29C 33/40; H04R 25/00

(52) U.S. Cl. 381/312; 264/222

(57) ABSTRACT

The invention relates to a method for the manufacture of a communication device, which is carried in or partly in the ear channel of the user. The device has a casing comprising a shell part shaped to fit the ear and ear channel of the user and a faceplate. The shell and the faceplate are joined to enclose the electronic parts of the communication device, whereby markings on the faceplate indicate the orientation of an anatomical structure of the ear. The markings are used to correctly orient shell and faceplate with respect to each other before joining the two, in the absence of marking of the horizontal line in the ear impression and thereby in the shell. The invention further comprises a faceplate for use in the manufacture of a communication device carried in or partly in the ear channel of the user. The communication device has a casing comprising a shell part shaped to fit the ear and ear channel of the user, and a faceplate constituting the visual part of the communication device when in use, whereby the faceplate has markings indicating the orientation of the tragus-line.

### AREA OF THE INVENTION

The invention concerns a method for the manufacture of a communication devise which is carried in or partly in the ear channel of the user, the device having a casing comprising a shell part shaped to fit the ear and ear channel of the user and a faceplate where the shell and the faceplate are joined to enclose the electronic parts of the communication device.

The invention further concerns a faceplate for use in the manufacture of a communication device carried in or partly in the ear channel of the user, where the communication device has a casing comprising a shell part shaped to fit the ear and ear channel of the user, and a faceplate constituting the visual part of the communication device when in use.

### BACKGROUND OF THE INVENTION

In the production of a communication device of this type, an impression of the users ear and ear channel is taken and on the basis thereof a mould is produced wherein a shell, which fits exactly to the users ear may be cast. Other ways of producing the shell are possible, but casting in this way is the most common. The faceplate and the shell are then assembled around the electronic parts responsible for the function of the communication device. Producing the mould, casting the shell and assembling shell and faceplate may take place at a central production facility remote from the place and persons involved in taking the impression of the user ear. In certain of the communication devices being produced, it is important that the faceplate has a well-defined horizontal orientation with respect to the users head. This is especially important with directional hearing aids. When the impression of the ear and ear channel is made, an alignment mark to indicate the horizontal line should be made, in order to facilitate the orientation of the face plate with respect to the shell, once shell and face plate are to be assembled. Sometimes the person taking the impression forgets this part of the procedure and thus omits to indicate the horizontal line in the cast. In this case the persons assembling the shell and faceplate cannot easily ensure the correct orientation of the faceplate with respect to the shell.

The invention seeks to solve this problem and facilitate mounting of the faceplate in a horizontal position with respect to the head of the user, even when the shell has no marking of the horizontal direction.

### SUMMARY OF THE INVENTION

The invention solves the above defined problem by means of a method as defined in claim 1 and a faceplate as defined in claim 4.

By the markings on the faceplate indicating the orientation of an anatomic structure and the use of said markings, in the absence of marking of the horizontal line in the shell, to orient shell and faceplate before joining the two, the persons fitting the faceplate to the shell can now ensure a good orientation of the shell and faceplate with respect to each other. This may be done even when there are no indications as to the horizontal direction of the shell. This is possible when an anatomic structure is used, which has the same inclination with respect to the horizontal direction in most human ears. The shell is normally made in a method whereby an impression is made of the ear and ear channel, and the shell is produced on the basis thereof. Normally the shell is made to include a sufficient part of the ear to allow identification of various anatomical structures with a well-defined orientation with respect to the horizontal or vertical plane of the head.

In one embodiment of the invention the tragus-line in the ear is uses as the anatomical structure. The tragus-line is defined as the line passing through the point defined by the base of the tragus and antitragus and the point defined by the crossing point of the base of the antihelix and the helix.

When fitting the faceplate to the shell, it is usually the object to achieve the smallest possible size of the device. This is done by progressively machining the edge of the shell, until a size is obtained which will just allow the electronic parts to fit into the hollow defined by the faceplate and the shell when assembled. In this process the points indicating the tragus-line may be lost. Therefore the orientation of the tragus-line in some cases has to be indicated elsewhere at the shell before excessive machining makes identification of the tragus-line impossible. This is achieved by the method of claim 4.

### BRIEF DESCRIPTION OF THE DRAWINGS

FIG. 1 is a front view of a faceplate according to one embodiment of the invention,

FIG. 2 is a view of the back side of the faceplate in FIG. 1 and,

FIG. 3 is a side view of a human ear with indications of the horizontal line, the tragus line and the structures defining the tragus-line.

### DESCRIPTION OF A PREFERRED EMBODIMENT

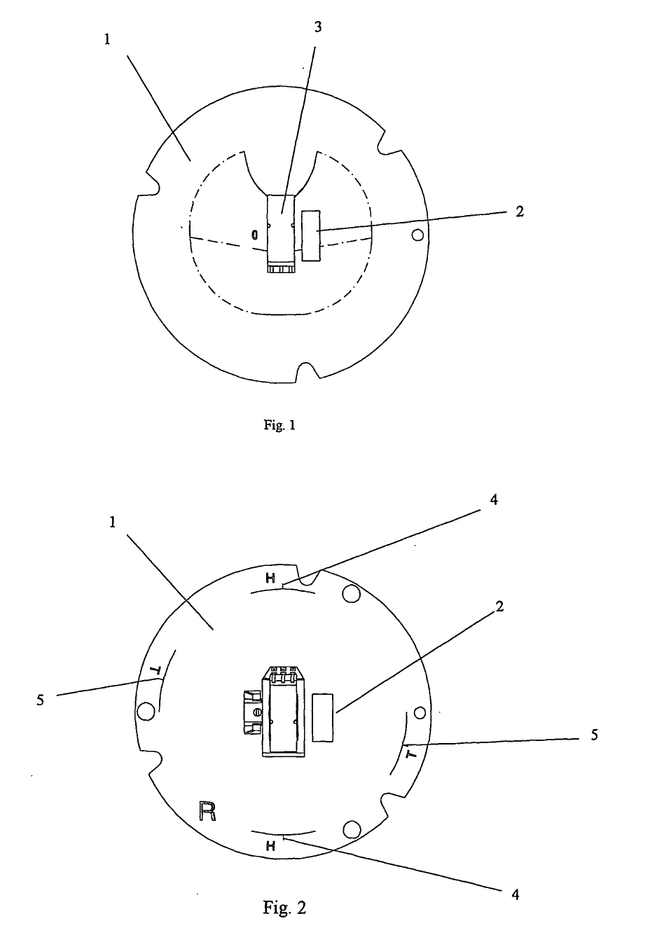

The faceplate 1 in FIG. 1 is a usual faceplate common in the art, with an opening 3 for the battery and an opening 2 for a microphone (not shown). The microphone opening 2 is designed to receive a directional microphone. This microphone is more sensitive in a certain direction, and when in use it is important for the sense of directionality experienced by the user that the sensitive direction is oriented with respect to the vertical and horizontal axis of the head.

In FIG. 2 the backside of the face plate 1 is shown, and a first set of markings 4 are placed at the rim indicating the horizontal direction. When faceplate 1 and shell is assembled, the usual practice is to align the first set of markings 4 with markings on the shell indicating the horizontal direction of the shell.

However, the markings on the shell may at times not be present, which is the case, when during initially making the impression of the ear and ear channel such marking has not been made. This mistake leaves the person, who assembles the device, with the problem of how to orient the shell properly with the shell plate, without any indication as to how the shell should be oriented in order to assure the correct orientation of the microphone when the device is placed in the ear of the user. In many cases the person will attempt to perform the orientation on the basis of previous experience, and in some cases this results in a satisfactory device, but in other cases the device does not perform satisfactory and the user will react with disappointment. The user may not always realize the real cause of the poor performance of the hearing aid, and in such cases the user may conclude, that the newly acquired hearing aid as such has a poor performance. Such negative evaluation by the user is harmful to the reputation of the manufacture of the hearing aid, and greate care is taken to avoid this.

However, dispensers of hearing aids are usually not under the control of the manufacture and mistakes of the above mentioned nature cannot be totally avoided.

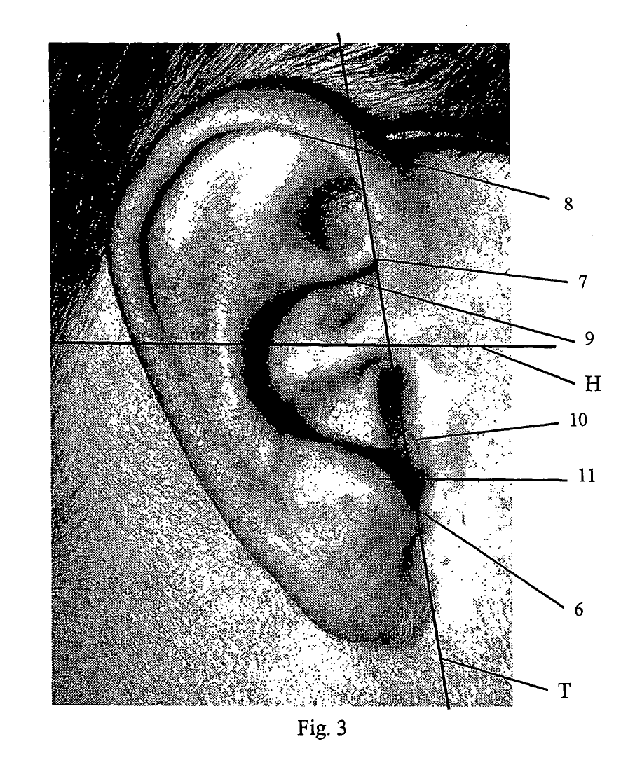

It has now been shown that the human ear has easily recognizable points, which are always placed in the same way with respect to the vertical and horizontal axis of the head. Referring to FIG. 3 this is the tragus notch 6 defined by the intersection of tragus 10 and antitragus 11 structures and the point 7 defined by the cross over of the borderlines of the helix 8 and antihelix 9 structures, said last point is also known as the symba concha 7. The line through these two points called the tragus-line T has a well defined angle with respect to the horizontal axis H of the head. In human ears the variation of this angle lies within a narrow range. The two points 6,7 and the line T through them may easily be identified in the shell before the assembly of shell and faceplate 1 is started.

When the shell and the faceplate 1 are assembled the tragus-line T may then be used in the event that indication of the horizontal axis of the users head are not present on the shell. The assembly of the shell and faceplate 1 is accomplished by the use of the marking of the tragus-line in the shell and the tragus markings 5 on the rim of the faceplate 1. In many cases the tragus-line is transferred to the base of the shell before machining of the edge to the final height of the shell. This height is defined by the available space in the ear channel and the volume of the electrical parts to be fitted in the device. Once this height is reached the transferred tragus-line may be used to orient the shell and faceplate. Thereby a good orientation of the faceplate 1 with respect to the shell is achieved in most cases even if the horizontal line is not marked in the shell.

The invention is primarily used to secure the correct orientation of the faceplate with respect to the horizontal axis of the users head in hearing aids with directional microphones. The invention may however be used in connection with other hearing aids in the ear channel when a clearly defined orientation of the faceplate is desired.

1. A method for the manufacture of a communication device which is carried in or partly in the ear channel of the user, the device having a casing comprising a shell part shaped to fit the ear and ear channel of the user and a faceplate (1), where the shell and the faceplate (1) are joined to enclose the electronic parts of the communication device, whereby markings (5) on the faceplate (1) indicate the orientation of an anatomic structure of the ear, and that said markings (5), in the absence of marking of the horizontal line in the shell, are used to correctly orient shell and faceplate (1) with respect to each other before joining the two.

2. A method as defined in claim 1, whereby said anatomic structure is the tragus-line (T).

3. A method as defined in claim 2, whereby the shell is successively machined along its edge to produce the smallest possible device, and where the tragus-notch (6) and the symba concha (7) of the shell are used to identify the orientation of the tracus line following which the orientation of the tragus-line (T) is indicated at that part of the shell which will form the casing before possible machining away of the tragus-notch (6) and the symba concha (7) defining the tragus-line (T).

4. A faceplate (1) for use in the manufacture of a communication device carried in or partly in the ear channel of the user, where the communication device has a casing comprising a shell part shaped to fit the ear and ear channel of the user, and a faceplate (1) constituting the visual part of the communication device when in use, whereby the faceplate (1) has markings indicating the orientation of an anatomical structure of the ear.

5. A faceplate (1) as defined in claim 4 where the anatomical structure is the tragus-line (T).

6. A faceplate (1) as defined in claim 4, where the faceplate (1) in addition to the markings (5) indicating the orientation of an anatomical structure has markings (4) indicating the horizontal direction.
